(19) United States
(12) Patent Application Publication
(10) Pub. No.: US 2025/0223052 A1
(43) Pub. Date: Jul. 10, 2025

(54) METHOD FOR MONITORING THE OPERATION OF A ROTORCRAFT POWER PLANT AND ASSOCIATED ROTORCRAFT

(71) Applicant: AIRBUS HELICOPTERS, Marignane Cedex (FR)

(72) Inventors: Arnaud MILLET, Pelissanne (FR); Guillaume DUMUR, Salon De Provence (FR)

(73) Assignee: AIRBUS HELICOPTERS, Marignane Cedex (FR)

(21) Appl. No.: 18/918,226

(22) Filed: Oct. 17, 2024

(30) Foreign Application Priority Data
Jan. 8, 2024 (FR) 2400151

(51) Int. Cl. B64D 45/00; G01M 15/14

(52) U.S. Cl. CPC B64D 45/00; G01M 15/14; B64D 2045/0085

(57) ABSTRACT

A method for monitoring the operation of a power plant of a rotorcraft and a rotorcraft comprising at least one lift rotor rotated by the power plant comprising at least one engine. Such a rotorcraft comprises a monitoring system comprising at least one failure sensor detecting a regulation failure affecting a regulation system of the at least one engine, a speed sensor measuring a current speed of rotation of the at least one lift rotor and a controller determining whether there is a condition of compatibility or a condition of incompatibility between a current flight phase and the speed of rotation.

### CROSS REFERENCE TO RELATED APPLICATIONS

This application claims the benefit of FR 2400151 filed on Jan. 8, 2024, the disclosure of which is incorporated in its entirety by reference herein.

### FIELD OF THE INVENTION

The present disclosure relates to a method for monitoring the operation of a rotorcraft power plant.

### BACKGROUND

A rotorcraft comprises at least one rotor helping provide lift for the rotorcraft and possibly also propulsion.

For example, a rotorcraft may comprise a main rotor helping provide lift and propulsion for the rotorcraft, this main rotor having blades with collectively and cyclically variable pitch. The rotorcraft may also comprise a system that helps control the yaw motion, such as another main rotor or a rear rotor, for example. The pitch control system can be activated, for example, by the pilot or the crew. Alternatively, the system can be activated by an automatic control system referred to as an autopilot.

In order to rotate the rotor or rotors, the rotorcraft comprises a power plant, that may be a multi-engine power plant, and a power transmission system leading from the engines to one or more rotors.

For example, two engines are connected to a gearbox, this gearbox rotating the rotor or rotors. The gearbox then comprises one mechanical input for each engine, the mechanical inputs being engaged with a mixing unit, the mixing unit driving one mechanical output of the gearbox for each rotor. The engine inputs, the mixing unit and the mechanical outputs may comprise at least one pinion or one toothed wheel, at least one shaft, at least one speed reduction stage, etc.

The engines may be heat engines having an output shaft set in motion by the combustion of fuel. For example, at least one engine may be a turboshaft engine provided with a gas generator and a free working turbine connected to the output shaft.

Each engine may be controlled by a regulation system known as a Full Authority Digital Engine Control or FADEC. Such a regulation system comprises an engine computer in communication with sensing devices measuring values of operating parameters of the controlled engine, or of the rotorcraft, such as a speed of rotation of a gas generator or free turbine, an internal temperature or a speed of rotation of a rotor of the rotorcraft.

This engine computer is then configured to control a fuel metering valve supplying the associated engine in order, for example, to stabilize a speed of rotation of the output shaft at a setpoint speed, regardless of the power consumed by this output shaft. This power varies depending on the actions of a pilot on flight controls, in particular on controls that collectively and/or cyclically vary the pitch of the blades of the main rotor on a rotorcraft. Alternatively, these flight controls may be actuated by an autopilot.

Implementing regulation as a function of the speed of rotation of the output shafts of the engines ensures that the power produced together by the output shafts of these engines is permanently matched to the power consumed by the rotor or rotors, such that the rotor or rotors rotate at a nominal speed of rotation compatible with its or their function of generating lift for the rotorcraft.

However, the engine computer is configured to prevent the power developed by an engine from exceeding a mechanical limit acceptable to the engine or the power transmission system. Conventionally, various operating modes associated with specific limits and durations of use are defined. For each operating mode, these limits may comprise, for example, a limit on the torque delivered by an engine, a limit on an internal temperature of an engine, a limit on the speed of rotation of an engine shaft, a limit on the torque of at least one member of the power transmission system, etc.

Operating modes known on a multi-engine aircraft include “All Engines Operating” or AEO operating modes, that can be used for certain periods of time when all of the engines are operating normally, and “One Engine Inoperative” or OEI operating modes, that can be used for certain periods of time when one of the engines has failed. Using certain operating modes may result in maintenance work needing to be carried out on the engines or on the power transmission system.

Therefore, an engine computer controls a system for regulating the fuel metering valve in such a way as to modulate the power of the associated engine. The system for regulating the fuel metering valve is thus configured to bring the speed of rotation of the output shaft towards a setpoint value, while avoiding exceeding a limit.

Moreover, in the event of a fault or failure of the regulation system of an engine, the flow rate of fuel supplying the engine in question is fixed at the most recent flow rate value used. A pilot is informed of this and may then either switch off the engine in question, for safety reasons, or continue the flight as is, i.e., with an engine that is not under regulation.

More generally, managing an absence of regulation of one of the engines of a rotorcraft may be complicated to implement in order to pilot such a rotorcraft in complete safety.

Documents GB2079707 and US 2011/173988 disclose systems for controlling an engine, such as a gas turbine, used in the event of another engine failing. However, such systems are far removed from the disclosure.

### SUMMARY

An object of the present disclosure is thus to propose a method that helps limit the workload of a crew in the event of a fault in a regulation system of an engine on a rotorcraft or in the absence of regulation of one of the engines. Furthermore, this method and the associated rotorcraft may enable a pilot to perform piloting maneuvers in complete safety, without the risk of degrading the mechanical power transmission system or a rotor of the rotorcraft.

The disclosure thus relates to a method for monitoring the operation of a rotorcraft power plant, the power plant comprising at least one engine, the rotorcraft comprising at least one lift rotor rotated by the power plant.

According to the disclosure, such a monitoring method is remarkable in that it comprises the following steps:
detecting a regulation failure affecting a regulation system of said at least one engine;
detecting a current speed of rotation NR of said at least one lift rotor;
determining whether there is a condition of compatibility or a condition of incompatibility between a current flight phase and the speed of rotation NR;
in a first operating mode, in the presence of the condition of compatibility and the regulation failure, generating a first alert simultaneously representative of the regulation failure and the condition of compatibility; and
in a second operating mode, in the presence of the condition of incompatibility and the regulation failure, generating a second alert simultaneously representative of the regulation failure and the condition of incompatibility.

Furthermore, when there is a failure in the regulation of an engine, the fuel metering valve supplying fuel to a combustion chamber of the associated engine then remains blocked in a current position and continues to deliver a constant flow of fuel. Depending on the current flight phase, and in particular a change in the pitch control of the rotor blades, the speed of rotation NR of the rotor may then change, uncontrolled, and depart from a nominal operating range.

Furthermore, the current flight phase may be identified by the monitoring method or identified by another method and transmitted in order to make it possible to determine whether the condition of compatibility or, alternatively, the condition of incompatibility, applies.

In the first operating mode, such a monitoring method makes it possible for a pilot to continue a flight phase despite the failure in the regulation of at least one engine, as long as the speed of rotation NR is kept within a nominal operating range for the current flight phase.

The first alert is thus generated only for information purposes and the pilot can continue his or her mission without needing to take any particular action.

In the second operating mode, if the failure in the regulation of at least one engine is still present and the speed of rotation NR departs from the nominal operating range for the current flight phase, the second alert may allow the pilot to perform a predetermined emergency procedure. For example, the pilot may perform an action that returns the speed of rotation NR to its nominal range or switch off the engine affected by the regulation failure.

Such a second alert is different from the first alert so as to enable to pilot to distinguish between them.

Furthermore, each alert may be in the form of a visual alarm, for example emitting a light with a light-emitting diode or an equivalent or one or more characters being displayed on a screen, an audible alarm, via a loudspeaker, and/or a haptic alarm, for example by means of a vibrating unit causing a member held or worn by an individual to vibrate.

According to a first embodiment of the disclosure, the condition of compatibility may be identified when the current speed of rotation NR lies within a range of values defined by a rotational speed setpoint minus a first margin (n) and the rotational speed setpoint plus a second margin (m) and, alternatively, the condition of incompatibility may be identified when the current speed of rotation NR lies outside this range of values.

In other words, in this case, the condition of compatibility and the condition of incompatibility are functions of a current rotational speed setpoint, a first margin (n) and a second margin (m). The first margin (n) and the second margin (m) may, for example, consist of a percentage of the rotational speed setpoint.

In practice, the rotational speed setpoint may be variable as a function of the current flight phase.

Such a rotational speed setpoint may be generated by a flight control computer of a flight management system of the rotorcraft as a function, in particular, of atmospheric conditions of the flight phase and control setpoints used by the pilot to control the rotorcraft.

Similarly, the first margin (n) and the second margin (m) may be variable as a function of the current flight phase.

Indeed, according to the current flight phase, the first and second margins (n) and (m) may be modified and thus make it possible to adapt the limits of the nominal operating range corresponding to the acceptable values for the speed of rotation NR of the rotor.

According to a second embodiment of the disclosure, the condition of compatibility may be identified when the current speed of rotation NR lies within a predetermined range of acceptable values allowing the current flight phase to be continued and, alternatively, the condition of incompatibility may be identified when the current speed of rotation NR lies outside the predetermined range of acceptable values allowing the current flight phase to continue.

In this case, the limits of the nominal operating range corresponding to the acceptable values for the speed of rotation NR of the rotor are fixed and predefined, for example by ground tests, flight tests or simulations.

In this case, the predetermined range may comprise an upper limit defined such that a tangential speed at the blade tip of a blade of said at least one lift rotor is kept below the speed of sound.

Such an upper limit may therefore help ensure the integrity of the lift rotor. Alternatively, or additionally, this upper limit may be defined in order to allow the rotorcraft to achieve maximum performances during a flight phase referred to as a hovering flight phase or at low speed and/or in order to limit the noise footprint generated by the rotation of the rotor in a cabin of the rotorcraft.

Similarly, the predetermined range may comprise a lower limit defined in order to provide a minimum thrust enabling the rotorcraft to fly at a constant altitude at a forward cruising speed.

The lower limit may be chosen so as to help reduce the noise footprint of a rotorcraft in the outside environment. Indeed, such a noise footprint is directly linked to the speed of rotation NR of the rotor and increases when the speed of rotation NR increases.

Alternatively, or additionally, this lower limit may be defined in order to prevent the altitude of the rotorcraft dropping too much in the event of an engine failure and before it is able to reach a rotor speed enabling it to operate an autorotation flight phase.

In practice, shifting from the first operating mode to the second operating mode may be irreversible.

Such irreversibility provides additional protection. It helps contribute to flight safety and minimize the risk of confusion for the pilot.

Advantageously, generating the first alert may comprise a first display step wherein at least one item of information is displayed on a display unit in a first predetermined color.

This information may, for example, comprise an alphanumeric message or a geometric shape such as, in particular, a band, a rectangle, a diamond, a circle, a line, etc.

The display unit may, for example, comprise a screen of an instrument panel of the rotorcraft or a display device referred to as a “head-up” display device that may, in particular, be worn by the pilot and be integrated into goggles or a helmet screen.

The first predetermined color may, for example, be amber or orange.

Similarly, generating the second alert may comprise a second display step wherein said at least one item of information is displayed on the display unit in a second predetermined color different from the first predetermined color.

This information may, for example, comprise an alphanumeric message or a geometric shape such as, in particular, a band, a rectangle, a diamond, a circle, a line, etc.

The message and/or the geometric shape of this second alert may be the same as those of the first alert, but the second predetermined color may, for example, be red, and therefore different from an amber or orange color.

Furthermore, said at least one engine may, for example, comprise a first engine and a second engine. In this case, when there is a switch to the second operating mode, the method may implement other additional steps designed to return the speed of rotation NR of the rotor to its nominal operating range.

Therefore, according to a first variant, if the regulation failure affects a first regulation system of the first engine, when the second alert is generated, the method may comprise a command to stop the first engine.

Such a command to stop the first engine may, for example, consist in closing a solenoid valve supplying fuel to the first engine. Once the solenoid valve is closed, a first fuel metering valve connected to the combustion chamber of the first engine can no longer supply fuel, and the first engine stops. However, the rotor continues to be rotated by the second engine, the regulation system of which is not affected by a failure.

According to a second variant, if the regulation failure affects a first regulation system of the first engine, when the second alert is generated, the method may comprise controlling a reversible transmission device to prevent engine torque from being transmitted from the first engine to a power transmission system.

Such controlling of a reversible transmission device of the first engine may, for example, consist in disengaging a clutch system or a controlled free-wheel arranged between an output shaft of the first engine and an input shaft of a gearbox. In this case, the first engine does not stop, but it no longer supplies engine torque to the rotor via the power transmission system.

The object of the present disclosure is also a rotorcraft comprising at least one lift rotor rotated by a power plant, the power plant comprising at least one engine.

According to the disclosure, such a rotorcraft is remarkable in that it comprises a monitoring system comprising:
at least one failure sensor detecting a regulation failure affecting a regulation system of said at least one engine;
a speed sensor measuring a current speed of rotation NR of said at least one lift rotor; and
a controller determining whether there is a condition of compatibility or a condition of incompatibility between a current flight phase and the speed of rotation NR,
the controller generating, in a first operating mode, in the presence of the condition of compatibility and the regulation failure, a first alert simultaneously representative of the regulation failure and the condition of compatibility; and
the controller generating, in a second operating mode, in the presence of the condition of incompatibility and the regulation failure, a second alert simultaneously representative of the regulation failure and the condition of incompatibility.

Furthermore, such a failure sensor may be integrated into the regulation system of said at least one engine, that is connected to the controller via wired or wireless means. The failure sensor thus transmits the information about the failure of the regulation system in question directly to the controller.

Similarly, the speed sensor may be integrated into a flight management system that is connected to the controller via wired or wireless means. Such a flight management system also transmits information representative of the flight conditions in order to deduce a current flight phase therefrom.

Based on the received information, the controller deduces the condition of compatibility or the condition of incompatibility between the current flight phase and the speed of rotation NR.

When the information about the regulation failure is received, the controller may then determine whether it needs to implement the first operating mode or the second mode and thus generate the corresponding alert.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a side view diagram of a rotorcraft equipped with a monitoring system according to the disclosure;

FIG. 2 is a logic diagram showing a monitoring method according to the disclosure;

FIG. 3 is a logic diagram showing a first alternative of the monitoring method according to the disclosure; and

FIG. 4 is a logic diagram showing a second alternative of the monitoring method according to the disclosure.

### DETAILED DESCRIPTION

Elements that are present in more than one of the figures are given the same references in each of them.

As already disclosed, the disclosure relates to a rotorcraft equipped with a system for monitoring a power plant and the associated monitoring method.

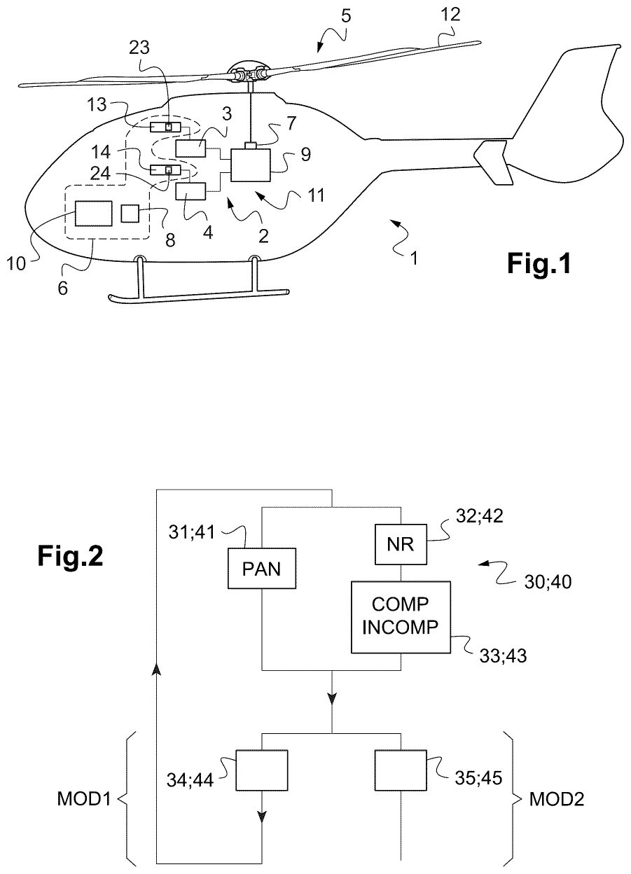

As shown in FIG. 1, such a rotorcraft 1 comprises a power plant 2 provided with at least one engine 3, 4 allowing at least one lift rotor 5 to be rotated via a power transmission system 11. Such a power transmission system 11 may, in particular, comprise a gearbox 9 with at least one input shaft linked respectively to an output shaft of each engine 3, 4.

Such a gearbox 9 comprises a mechanical output intended to rotate a rotor mast constrained to rotate with said at least one lift rotor 5.

Furthermore, the flow rate of fuel supplying said at least one engine 3, 4 is regulated initially by a dedicated regulation system 13, 14 connected to a fuel metering valve, that is not shown.

The monitoring system 6 comprises at least one failure sensor 23, 24 capable of detecting a regulation failure PAN affecting the regulation system 13, 14 of said at least one engine 3, 4.

The monitoring system 6 also comprises a speed sensor 7 arranged, for example, at the rotor mast, and capable of measuring a current speed of rotation NR of said at least one lift rotor 5.

Failure sensor 23, 24 and speed sensor 7 should be understood to mean physical sensing devices capable of directly measuring the parameter in question but also a system that may comprise one or more physical sensing devices as well as means for processing the signal that make it possible to provide an estimation of the parameter based on the measurements provided by these physical sensing devices. Similarly, the notion of measuring this parameter refers to both a raw measurement from a physical sensing device and a measurement obtained by relatively complex processing of one or more raw measurement signals.

The monitoring system 6 comprises a controller 8 connected via wired or wireless means with the speed sensor 7 and a set of other sensing devices that are not shown, for example from a flight management system of the rotorcraft 1, configured to make it possible to identify a current flight phase of the rotorcraft 1.

The set of sensing devices configured to identify a current flight phase may in particular comprise, but is not limited to, an air data computer ADC, an attitude and heading reference system AHRS, a radio altimeter Rad Alt and a global positioning system GPS.

In the non-limiting embodiment described, the air data computer ADC provides the monitoring system 6 with the pressure altitude, the air speed of the rotorcraft 1 and the raw vertical speed of the rotorcraft 1.

In the non-limiting embodiment described, the attitude and heading reference system AHRS provides the monitoring system 6 with attitude, heading, acceleration and rate of sink information.

With the input of the air data computer ADC, the attitude and heading reference system AHRS provides the instantaneous vertical speed.

With the input of a global positioning system GPS and/or a flight management system FMS, the attitude and heading reference system AHRS provides a combined navigation position and ground speed in each direction.

The radio altimeter Rad Alt provides the height of the rotorcraft 1 above the ground and water.

The controller 8 therefore makes it possible to determine whether there is a condition of compatibility COMP or a condition of incompatibility INCOMP between a current flight phase and the speed of rotation NR.

By way of example, the controller 8 may also comprise at least one processor and at least one memory, at least one integrated circuit, at least one programmable system, or at least one logic circuit, these examples not limiting the scope to be given to the term “controller”. The term “processor” may refer equally to a central processing unit or CPU, a graphics processing unit or GPU, a digital signal processor or DSP, a microcontroller, etc.

Furthermore, the monitoring system 6 may also comprise a display unit 10 for displaying two different items of alert information to a pilot of the rotorcraft 1 when a regulation failure PAN is detected.

Furthermore, according to FIGS. 2 to 4, the disclosure also relates to a method 30, 40 for monitoring the operation of the power plant 2 rotating the lift rotor or rotors 5.

Moreover, instructions or a computer program may be stored in a memory of the monitoring system 6. The monitoring system 6 may execute these instructions or this program in order to implement the monitoring method 30, 40.

Such a monitoring method 30, 40 therefore comprises detecting 31, 41 a regulation failure PAN affecting a regulation system 13, 14 of said at least one engine 3, 4.

The monitoring method 30, 40 also comprises detecting 32, 42 the current speed of rotation NR of said at least one lift rotor 5 and determining 33, 43 whether there is a condition of compatibility COMP or a condition of incompatibility INCOMP between a current flight phase and the speed of rotation NR. Hence, the condition of compatibility COMP and the condition of incompatibility INCOMP are two conflicting conditions that cannot be satisfied simultaneously.

Therefore, in a first operating mode MOD1, in the presence of the condition of compatibility COMP and the regulation failure PAN, the monitoring method 30, 40 comprises generating 34, 44 a first alert simultaneously representative of the regulation failure PAN and the condition of compatibility COMP.

Alternatively, and in a second operating mode MOD2, in the presence of the condition of incompatibility INCOMP and the regulation failure PAN, the monitoring method 30, 40 comprises generating 35, 45 a second alert simultaneously representative of the regulation failure PAN and the condition of incompatibility INCOMP.

Furthermore, the shift from the first operating mode MOD1 to the second operating mode MOD2 may be irreversible for flight safety reasons.

The steps of generating 34, 44 a first alert and generating 35, 45 a second alert are thus implemented by the controller 8, that is capable of generating at least two alerts that are different from each other and thus informing the pilot of the rotorcraft 1 of a current safety level allowing or prohibiting the continuation of a mission in the event of a regulation failure PAN.

Furthermore, different alternatives can be used to determine whether the condition of compatibility COMP or the condition of incompatibility INCOMP applies.

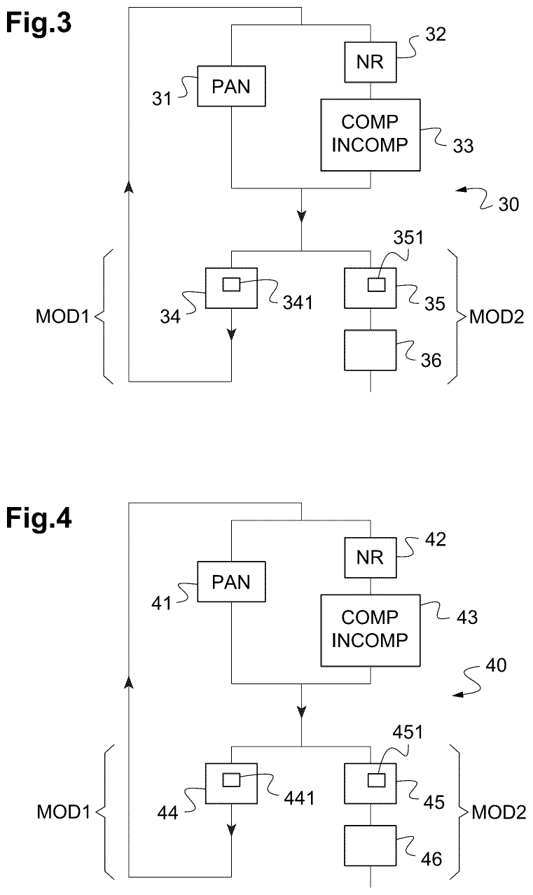

According to a first alternative of the monitoring method 30 shown in FIG. 3, the condition of compatibility COMP is, for example, identified when the current speed of rotation NR lies within a range of values defined by a rotational speed setpoint NRcons minus a first margin n and the rotational speed setpoint NRcons plus a second margin m and, alternatively, the condition of incompatibility INCOMP is identified when the current speed of rotation NR lies outside this range of values.

In practice, such a rotational speed setpoint NRcons may be variable as a function of the current flight phase identified by the controller 8.

Similarly, the first margin n and the second margin m may also be variable as a function of the current flight phase.

Moreover, generating 34 the first alert may comprise a first display step 341 wherein at least one item of information is displayed on the display unit 10 in a first predetermined color.

Generating 35 the second alert may comprise a second display step 351 wherein said at least one item of information is displayed on the display unit 10 in a second predetermined color different from the first predetermined color.

For example, the first predetermined color may be amber and the second predetermined color may be red.

Said at least one item of information may, for example, comprise am alphanumeric message “FAIL” indicating a regulation failure PAN and being supplemented with the regulation system in question 13 or 14, “FADEC1” or “FADEC2”.

Moreover, when the rotorcraft 1 comprises a first engine 3 and a second engine 4, and the regulation failure PAN affects the first regulation system 13 of the first engine 3, the method 30 may comprise a command 36 to stop the first engine 3.

Such a command 36 may be implemented after generating 35 the second alert, for example automatically after a predetermined time interval, or manually by a pilot of the rotorcraft 1.

According to a second alternative of the monitoring method 40 shown in FIG. 4, the condition of compatibility COMP may be identified when the current speed of rotation NR lies within a predetermined range of acceptable values allowing the current flight phase to be continued and, alternatively, the condition of incompatibility INCOMP may be identified when the current speed of rotation NR lies outside this predetermined range of acceptable values.

For example, the predetermined range may comprise an upper limit defined such that a tangential speed at the blade tip of a blade 12 of said at least one lift rotor 5 is kept below the speed of sound.

Similarly, the predetermined range may comprise a lower limit defined in order to provide a minimum thrust enabling the rotorcraft 1 to fly at a constant altitude at a forward cruising speed.

Moreover, generating 44 the first alert may comprise a first display step 441 wherein at least one item of information is displayed on the display unit 10 in a first predetermined color.

Generating 45 the second alert may comprise a second display step 451 wherein said at least one item of information is displayed on the display unit 10 in a second predetermined color different from the first predetermined color.

Said at least one item of information may, for example, comprise an amber-colored luminous geometric shape such as a rectangle or band to represent the first alert and, alternatively, the same rectangle or band shape colored red to represent the second alert.

Furthermore, such a luminous geometric shape may be displayed in the background of a digital indicator displaying a current value of the speed of rotation NR.

Moreover, when the rotorcraft 1 comprises a first engine 3 and a second engine 4, and the regulation failure PAN affects the first regulation system 13 of the first engine 3, the method 40 may comprise controlling 46 a reversible transmission device to prevent engine torque from being transmitted from the first engine 3 to the power transmission system 11.

Such a control 46 may be implemented after generating 45 the second alert, for example automatically after a predetermined time interval, or manually by a pilot of the rotorcraft 1.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure.

What is claimed is:

1. A method for monitoring the operation of a power plant of a rotorcraft, the power plant comprising at least one engine, the rotorcraft comprising at least one lift rotor rotated by the power plant,
wherein the monitoring method comprises the following steps:
detecting a regulation failure affecting a regulation system of the at least one engine;
detecting a current speed of rotation of the at least one lift rotor;
determining whether there is a condition of compatibility or a condition of incompatibility between a current flight phase and the speed of rotation;
in a first operating mode, in the presence of the condition of compatibility and the regulation failure, generating a first alert simultaneously representative of the regulation failure and the condition of compatibility; and
in a second operating mode, in the presence of the condition of incompatibility and the regulation failure, generating a second alert simultaneously representative of the regulation failure and the condition of incompatibility.

2. The method according to claim 1,
wherein the condition of compatibility is identified when the current speed of rotation lies within a range of values defined by a rotational speed setpoint minus a first margin and the rotational speed setpoint plus a second margin and, alternatively, the condition of incompatibility is identified when the current speed of rotation lies outside the range of values.

3. The method according to claim 2,
wherein the rotational speed setpoint is variable as a function of the current flight phase.

4. The method according to claim 2,
wherein the first margin and the second margin are variable as a function of the current flight phase.

5. The method according to claim 1,
wherein the condition of compatibility is identified when the current speed of rotation lies within a predetermined range of acceptable values allowing the current flight phase to be continued and, alternatively, the condition of incompatibility is identified when the current speed of rotation lies outside the predetermined range of acceptable values allowing the current flight phase to continue.

6. The method according to claim 5,
wherein the predetermined range comprises an upper limit defined such that a tangential speed at the blade tip of a blade of the at least one lift rotor is kept below the speed of sound.

7. The method according to claim 5,
wherein the predetermined range comprises a lower limit defined in order to provide a minimum thrust enabling the rotorcraft to fly at a constant altitude at a forward cruising speed.

8. The method according to claim 1,
wherein shifting from the first operating mode to the second operating mode is irreversible.

9. The method according to claim 1,
wherein the generating of the first alert comprises a first display step wherein at least one item of information is displayed on a display unit in a first predetermined color.

10. The method according to claim 9,
wherein the generating of the second alert comprises a second display step wherein the at least one item of information is displayed on the display unit in a second predetermined color different from the first predetermined color.

11. The method according to claim 1,
wherein, the at least one engine comprising a first engine and a second engine, the regulation failure affecting a first regulation system of the first engine, when the second alert is generated, the method comprises a command to stop the first engine.

12. The method according to claim 1,
wherein, the at least one engine comprising a first engine and a second engine, the regulation failure affecting a first regulation system of the first engine, when the second alert is generated, the method comprises controlling a reversible transmission device to prevent engine torque from being transmitted from the first engine to a power transmission system.

13. A rotorcraft comprising at least one lift rotor rotated by a power plant, the power plant comprising at least one engine,
wherein the rotorcraft comprises a monitoring system comprising:
at least one failure sensor detecting a regulation failure affecting a regulation system of the at least one engine;
a speed sensor measuring a current speed of rotation of the at least one lift rotor; and
a controller determining whether there is a condition of compatibility or a condition of incompatibility between a current flight phase and the speed of rotation,
the controller generating, in a first operating mode, in the presence of the condition of compatibility and the regulation failure, a first alert simultaneously representative of the regulation failure and the condition of compatibility; and
the monitoring controller generating, in a second operating mode, in the presence of the condition of incompatibility and the regulation failure, a second alert simultaneously representative of the regulation failure and the condition of incompatibility.
